(19) United States
(12) Patent Application Publication
(10) Pub. No.: US 2026/0038867 A1
(43) Pub. Date: Feb. 5, 2026

(54) APPARATUS FOR WINDING ELECTRODE PLATE OF RECHARGEABLE BATTERY

(71) Applicant: SAMSUNG SDI CO., LTD., Yongin-si (KR)

(72) Inventors: Doyeop HAN, Yongin-si (KR); Sungha KIM, Yongin-si (KR); Seung Yoon LEE, Yongin-si (KR)

(21) Appl. No.: 19/070,836

(22) Filed: Mar. 5, 2025

(30) Foreign Application Priority Data
Aug. 5, 2024 (KR) 10-2024-0104204

(51) Int. Cl. H01M 10/04

(52) U.S. Cl. CPC H01M 10/0431; H01M 10/0468

(57) ABSTRACT

An apparatus for winding an electrode plate of a rechargeable battery includes: a supply roller configured to supply an electrode plate; a winding core portion configured to wind the electrode plate; and an insert unit that is disposed between the supply roller and the winding core portion, with the insert unit being configured to insert the electrode plate in a first direction that the winding core portion is disposed. The insert unit includes a clamp that extends in the first direction and supports the electrode plate to guide the electrode plate in the first direction. The insert unit also includes a front-end roller that is disposed on the clamp at a position adjacent to a front end of the clamp, with the front-end roller being configured to move in a second direction that crosses the first direction to press the electrode plate supported by the clamp.

### CROSS-REFERENCE TO RELATED APPLICATION

This application claims priority to and the benefit of Korean Patent Application No. 10-2024-0104204 filed in the Korean Intellectual Property Office on Aug. 5, 2024, the entire contents of which are incorporated herein by reference.

### BACKGROUND

### (a) Field

The present disclosure relates to an apparatus for winding an electrode plate of a rechargeable battery.

### (b) Description of the Related Art

A rechargeable battery is a battery that is capable of being repeatedly charged and discharged.

As the demand for wearable devices such as headphones, earphones, smartwatches, and body-attached medical devices that utilize wireless communication such as BLUETOOTH® increases, there is an increasing need for button batteries, which are ultra-small rechargeable batteries mounted on wearable devices. Such button batteries include an electrode assembly in which an electrode plate is wound in the form of a jelly roll.

A conventional apparatus for winding an electrode plate of a rechargeable battery includes a supply roller for supplying an electrode plate, a winding core portion, and an insert unit disposed between the supply roller and the winding core portion for inserting the electrode plate into the winding core portion. However, when a conventional apparatus winds an electrode plate of a ultra-small rechargeable battery, such as a button battery, the electrode plate inserted from an insert unit into a winding core portion may be shaken because a width of the electrode plate is small, thereby causing a miswinding problem.

### SUMMARY

An embodiment is to provide an apparatus for winding an electrode plate of a rechargeable battery that prevents miswinding of an electrode plate even when winding an electrode of on an ultra-small rechargeable battery electrode plate, such as a button battery.

One aspect of the present disclosure provides an apparatus for winding an electrode plate of a rechargeable battery including: a supply roller configured to supply an electrode plate; a winding core portion configured to wind the electrode plate; and an insert unit that is disposed between the supply roller and the winding core portion, the inserting unit being configured to insert the electrode plate in a first direction that the winding core portion is disposed, wherein the insert unit includes a clamp that extends in the first direction and supports the electrode plate to guide the electrode plate in the first direction and a front-end roller that is disposed on the clamp at a position adjacent to a front-end of the clamp, and the front-end roller being configured to move in a second direction that crosses the first direction to press the electrode plate supported by the clamp.

The insert unit may further include a clamp roller that is adjacent to a rear end of the clamp, with the insert unit being configured to press the electrode plate.

A diameter of the clamp roller may be larger than a diameter of the front-end roller.

The clamp roller may include: a first roller contacting a bottom surface of the electrode plate; and a second roller contacting a front surface of the electrode plate.

The clamp may include a hole, with the first roller being located in the hole.

The clamp roller may further include a roller driver that moves the second roller in the second direction.

The apparatus for winding an electrode plate of a rechargeable battery may further include a cutter that is disposed between the clamp and the winding core portion, with the cutter being configured to cut the electrode plate.

The front-end roller may be positioned closer to the cutter than the clamp roller is positioned to the cutter.

The front-end roller may be is disposed between the clamp roller and the cutter.

The front-end roller may be configured to move in the second direction according to the cutting of the electrode plate by the cutter such that the front-end roller selectively contacts the electrode plate.

The clamp may be configured to move in the first direction such that the front end of the clamp selectively moves through the cutting region of the cutter.

The clamp may be configured to move in the first direction such that a distance between the front end of the clamp and the winding core portion may be adjusted.

The insert unit may further include a clamp driver that supports the clamp and moves the clamp in the first direction.

The front-end roller may be configured to move in the second direction to thereby selectively contact the electrode plate.

The insert unit may further include a front-end roller driver that supports the front-end roller and moves the front-end roller in the second direction.

The front-end roller driver may include a linear cylinder portion that supports the front-end roller and moves in the second direction; and a bush portion that guides the linear cylinder portion in the second direction.

The front-end roller may include a pressing roller configured to press the electrode plate; and a bearing portion rotating the pressing roller.

The bearing portion may have a longer length than the roller in a third direction that crosses the first direction and the second direction.

The clamp may include a recessed portion that is recessed in the third direction, with the recessed portion corresponding to the bearing portion.

A width of the electrode plate may be 1 mm to 10 mm.

According to the embodiment, an apparatus for winding an electrode plate of a rechargeable battery can suppress shaking of an electrode plate even when winding an electrode plate of a ultra-small rechargeable battery electrode plate, such as a button battery.

### BRIEF DESCRIPTION OF THE DRAWINGS

FIG. 1 shows an apparatus for winding an electrode plate of a rechargeable battery according to an embodiment.

FIG. 2 is a perspective view of an insert unit of the apparatus for winding an electrode plate of a rechargeable battery according to an embodiment.

FIG. 3 is a perspective view of one region of the insert unit shown in FIG. 2.

FIG. 4 is a top plan view of the front end roller of the insert unit shown in FIG. 3.

FIG. 5 is a perspective view of the front roller driver shown in FIG. 3.

FIG. 6A-6C and FIGS. 7A-7C are perspective views of the electrode plate winding using the insert unit of the apparatus for winding an electrode plate of a rechargeable battery according to an embodiment.

FIGS. 8A and 8B are views of winding an electrode plate of a rechargeable battery according to an embodiment.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In addition, unless explicitly described to the contrary, the word “comprise”, and variations such as “comprises” or “comprising”, will be understood to imply the inclusion of stated elements but not the exclusion of any other elements.

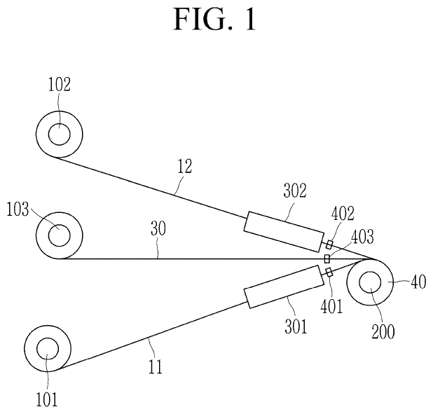

Hereinafter, referring to FIG. 1 to FIG. 5, an apparatus for winding an electrode plate of a rechargeable battery according to an embodiment will be described.

An apparatus for winding an electrode plate of a rechargeable battery according to an embodiment may be an apparatus for winding an electrode of an ultra-small rechargeable battery, such as a button battery. But the present disclosure is not limited to such an embodiment and may include apparatuses for winding electrodes of various known shapes and sizes of rechargeable batteries such as a cylindrical rechargeable battery or a square rechargeable battery.

A button battery is a battery in the shape of a thin coin or button and may refer to a battery with a height to diameter (height/diameter) ratio of 1 or less. But a button battery is not limited thereto. A button battery is often cylindrical, and thus the cross-section in the horizontal direction is circular. But a button battery is not limited thereto, and shapes in which the cross-section in the horizontal direction is oval or polygonal are possible. In this case, diameter may mean the maximum distance in the horizontal direction of the battery as a reference. Height may mean the maximum distance (the distance from the flat bottom surface to the flat top end surface) in the vertical direction, which is the thickness direction of the battery as a reference.

FIG. 1 shows an apparatus for winding an electrode plate of a rechargeable battery according to an embodiment.

Referring to FIG. 1, an apparatus for winding an electrode plate of a rechargeable battery according to an embodiment may include a first supply roller 101, a second supply roller 102, a third supply roller 103, a first insert unit 301, a second insert unit 302, a first cutter 401, a second cutter 402, a third cutter 403, and a winding core portion 200.

The first supply roller 101 may supply a first electrode plate to be wound into an electrode assembly 40 of the rechargeable battery. More specifically, the first supply roller 101 may supply a first electrode plate 11 that is wound from the winding core portion 200 to the electrode assembly 40 of the rechargeable battery. The first electrode plate 11 may include an anode, but is not limited thereto, and it may include a cathode. The first electrode plate 11 may have various known widths and lengths.

The first electrode plate 11 may be wound into a jelly roll-shaped electrode assembly 40 for a button battery. The first electrode plate 11 wound to the electrode assembly 40 may have a width of 1 mm to 10 mm and a length of 50 mm to 600 mm.

The second supply roller 102 may supply a second electrode plate to be wound into the electrode assembly 40 of the rechargeable battery. More specifically, the second supply roller 102 may supply the second electrode plate 12 that is wound by the winding core portion 200. The second electrode plate 12 includes a cathode, but is not limited to, and may include an anode. The second electrode plate 12 may have various lengths and widths. The second electrode plate 12 may be wound into the jelly roll-shaped electrode assembly 40 of the button battery. The second electrode plate 12 wound into the electrode assembly 40 may have a width of 1 mm to 10 mm or a length of 50 mm to 600 mm.

The third supply roller 103 may supply a separator 30 to be disposed between the first electrode plate 11 and the second electrode plate 12, which are wound onto the electrode assembly 40 of the rechargeable battery at the winding core portion 200. That is, the third supply roller 103 may supply the separator 30 that is wound into the electrode assembly 40 of the rechargeable battery. The separator 30 may include various known insulators.

The first insert unit 301 may be disposed between the first supply roller 101 and the winding core portion 200. The first insert unit 301 may insert the first electrode plate 11 in a direction in which the winding core portion 200 is disposed. The first electrode plate 11 supplied from the first supply roller 101 may be inserted into the winding core portion 200 through the first insert unit 301.

The second insert unit 302 may be disposed between the second supply roller 102 and the winding core portion 200. The second insert unit 302 may insert the second electrode plate 12 in the direction in which the winding core portion 200 is disposed. The second electrode plate 12 supplied from the second supply roller 102 may be inserted into the winding core portion 200 through the second insert unit 302.

The first cutter 401 may be disposed between the first insert unit 301 and the winding core portion 200. The first cutter 401 may cut the first electrode plate 11 when the jelly roll-shaped electrode assembly 40 is wound on the winding core portion 200. The first cutter 401 may include various known cutting means. The first cutter 401 may be mounted on the first insert unit 301, may be mounted on the winding core portion 200 adjacent to a mandrel of the winding core portion 200, or may be positioned between the first insert unit 301 and the winding core portion 200.

The second cutter 402 may be disposed between the second insert unit 302 and the winding core portion 200. The second cutter 402 may cut the second electrode plate 12 when the jelly roll-shaped electrode assembly 40 is wound on the winding core portion 200. The second cutter 402 may include various known cutting means. The second cutter 402 may be mounted on the second insert unit 302, may be mounted on the winding core portion 200 adjacent to the mandrel of the winding core portion 200, or may be positioned between the first insert unit 301 and the winding core portion 200.

The third cutter 403 may be disposed adjacent to the winding core portion 200. The third cutter 403 may cut the separator 30 when the jelly roll-shaped electrode assembly 40 is wound on the winding core portion 200. The third cutter 403 may include various known cutting means.

The winding core portion 200 may wind the first electrode plate 11, the second electrode plate 12, and the separator 30 into the jelly roll-shaped electrode assembly 40. The winding core portion 200 may include various known mandrels and is not limited in this regard. The electrode assembly 40 wound in a jelly roll shape by the winding core portion 200 may be included in a rechargeable battery.

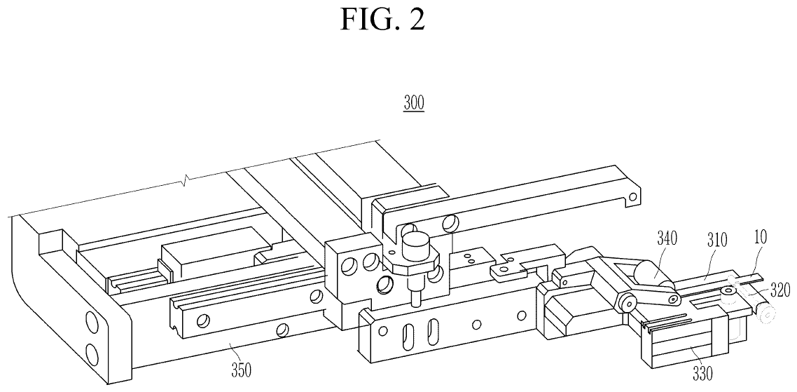

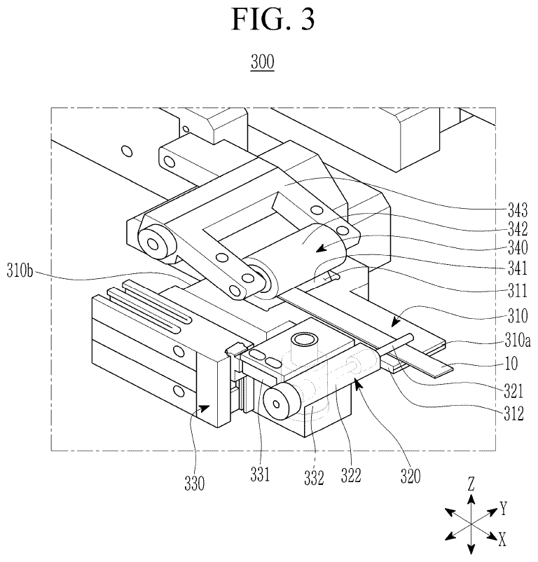

Hereinafter, referring to FIG. 2 to FIG. 5, an example of the insert unit of the apparatus for winding an electrode plate of a rechargeable battery according to an embodiment will be described. The insert unit may be the first insert unit 301 or second insert unit 302 described above with reference to FIG. 1. The electrode plate may be the first electrode plate 11 or second electrode plate 12 described above with reference to FIG. 1. FIG. 2 is a perspective view of an insert unit of the apparatus for winding an electrode plate of a rechargeable battery according to an embodiment. FIG. 3 is a perspective view of one region of the insert unit shown in FIG. 2. FIG. 3 is a perspective view of a front-end region of the insert unit.

Referring to FIGS. 2 and 3, an insert unit 300 of the apparatus for winding an electrode plate of a rechargeable battery according to an embodiment may insert the electrode plate 10 supplied from the supply roller in the first direction (X) in which the winding core portion is disposed.

The insert unit 300 may include a clamp 310, a front-end roller 320, a front end roller driver 330, a clamp roller 340, and a clamp driver 350.

The clamp 310 may be disposed at a front-end region of the insert unit 300. The clamp 310 may extend in the first direction (X) in which the winding core portion is disposed. The clamp 310 may support the electrode plate 10 and guide the electrode plate 10 in the first direction (X). More specifically, the clamp 310 may support a back surface of the electrode plate 10 and guide the electrode plate 10 in the first direction (X). The front-end roller 320 may be disposed on the clamp 310 adjacent to the front end 310a of the clamp 310. The clamp roller 340 may be disposed on a rear end 310b of the clamp 310 and the adjacent clamp 310. The clamp 310 may be moved in the first direction (X) by the clamp driver 350 that supports the clamp 310. A distance between the front end 310a of the clamp 310 and the winding core portion may be adjusted by moving of the clamp 310 along the first direction (X).

The clamp 310 may include a roller hole 311 and a recessed portion 312. The roller hole 311 may be disposed relative to the rear end 310b of the clamp 310 and the adjacent clamp roller 340. The first roller 341 of the clamp roller 340 may be disposed inside the roller hole 311.

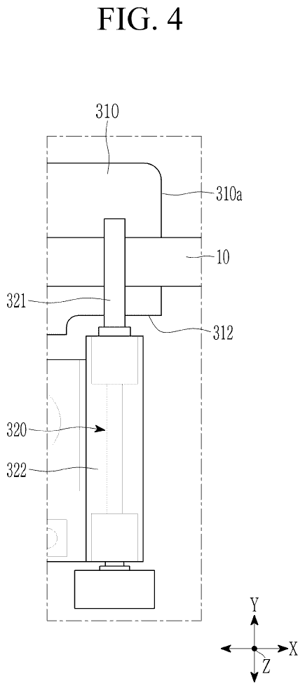

FIG. 4 is a top plan view of the front-end roller of the insert unit shown in FIG. 3.

Referring to FIGS. 3 and 4, the recessed portion 312 may be disposed at a position that corresponds to the front-end roller 320 and is adjacent to the front end 310a of the clamp 310. The recessed portion 312 may be recessed in a third direction (Y) intersecting the first direction (X) corresponding to a bearing portion 322 of the front-end roller 320. The bearing portion 322 of the front-end roller 320 may be disposed inside the recessed portion 312.

In embodiments, the first direction (X) and the third direction (Y) may include, but are not limited to, a horizontal direction.

The front-end roller 320 may be disposed on the clamp 310 at a position adjacent to the front-end 310a of the clamp 310. The front-end roller 320 may move in the second direction (Z) intersecting the first direction (X) and the third direction (Y) to pressurize and support the electrode plate 10 that is also supported by the clamp 310. The second direction (Z) may include, but is not limited to, a vertical direction intersecting the horizontal direction. The front-end roller 320 may be moved in the second direction (Z) by the front-end roller driver 330. A diameter of the roller included in the front-end roller 320 may be smaller than a diameter of the clamp roller 340.

Thus, there is less interference by the front-end roller 320 when the front end 310a of the clamp 310 moves in the first direction (X).

The front-end roller 320 may move in the second direction (Z) to selectively contact the electrode plate 10 supported by the clamp 310 and pressurize and support the electrode plate 10 together with the clamp 310. Since the front-end roller 320 presses and supports the electrode plate 10, which is supplied to the insert unit 300 and fed to the winding core portion, shaking of the electrode plate 10, in the first direction (X), second direction (Z), and third direction (Y) can be suppressed. For example, because the front-end roller 320 disposed on the clamp 310 adjacent to the front end 310a of the clamp 310 presses and supports the electrode plate 10, shaking of the electrode plate 10 can be suppressed.

The front-end roller 320 may include a pressing roller 321 and a bearing portion 322. The pressing roller 321 may press the electrode plate 10 by contacting the electrode plate. The pressing roller 321 may include various types of rollers. The bearing portion 322 rotatably supports the pressing roller 321 and may guide the rotation of the pressing roller 321. The bearing portion 322 may have a longer length in the third direction (Y) than the pressing roller 321. The bearing portion 322 may be disposed in the recessed portion 312 of the clamp 310. Because the bearing portion 322 has a longer length in the third direction (Y) than the pressing roller 321, the bearing portion 322 can be prevented from shaking due to the rotation of the pressing roller 321 that contacts and presses the electrode plate 10, the shaking of the pressing roller 321 itself is suppressed, and the shaking of the electrode plate 10 that is supported by the front end roller 320 can be suppressed.

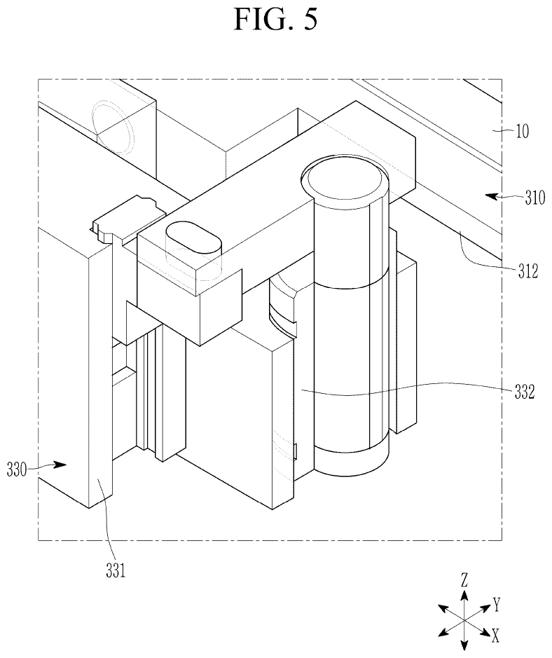

FIG. 5 is a perspective view of the front roller driver shown in FIG. 3. Referring to FIG. 3 to FIG. 5, the front-end roller driver 330 may support the front-end roller 320 and move the front-end roller 320 in the second direction (Z). That is, the front-end roller driver 330 is positioned adjacent to the clamp 310 and may support the front-end roller 320.

The front-end roller driver 330 may include a linear cylinder portion 331 and a bush portion 332. The linear cylinder portion 331 may support the front-end roller 320 and move in the second direction (Z). The linear cylinder portion 331 may include, but is not limited to, various known cantilever-shaped supports and linear cylinders.

The bush portion 332 may support and guide the linear cylinder portion 331 in the second direction (Z). The bush portion 332 may include, but is not limited to, an extension axis that supports a cantilever-shaped support member and extends in the second direction and a ball bush that guides the extension axis in the second direction.

Because the linear cylinder portion 331 supports the front end roller 320 and moves in the second direction (Z) and at the same time the bush portion 332 supports and guides the linear cylinder portion 331 in the second direction (Z), shaking of the linear cylinder portion 331 when moving in the second direction (Z) is suppressed. Thus, shaking of the front-end roller 320 supported by the linear cylinder portion 331 can be suppressed and shaking of the electrode plate 10 supported by the pressure of the front end roller 320 can be suppressed.

Referring to FIG. 3, the clamp roller 340 may be disposed on the clamp 310 at a position adjacent to the rear end 310b of the clamp 310. The clamp roller 340 may press and support the electrode plate 10 that is supplied to the insert unit 300. The electrode plate 10 is disposed between the first roller 341 disposed inside a roller hole 311 of the clamp 310 and the second roller 342 disposed on the first roller 341. The second roller 342 is moved in the second direction (Z) such that the clamp roller 340 can press and support the electrode plate 10 on the clamp 310 adjacent to the rear end 310b of the clamp 310.

A diameter of the roller included in the clamp roller 340 may be larger than a diameter of the front-end roller 320. Because the diameter of the clamp roller 340 is larger than that of the front-end roller 320, the electrode plate 10 can be firmly supported on the clamp roller 340 on the clamp 310 at a position that is adjacent to the rear end 310b of the clamp 310.

The clamp roller 340 presses and supports the electrode plate 10 on the clamp 310 adjacent to the rear end 310b of the clamp 310 and at the same time the front-end roller 320 presses and supports the electrode plate 10 on the clamp 310 adjacent to the front end 310a of the clamp 310. As such, shaking of the electrode plate 10 in the first direction (X), second direction (Z), and third direction (Y) can be suppressed. In other words, the clamp roller 340 disposed on the clamp 310 adjacent to the rear end 310b of the clamp 310 presses and supports the electrode plate 10 and at the same time the clamp roller 340 disposed on the clamp 310 adjacent to the rear end 310b of the clamp 310 presses and supports the electrode plate 10. Thus, shaking of the electrode plate 10, which is supported and guided by clamp 310, can be suppressed. Moreover, the clamp roller 340 disposed on the clamp 310 adjacent to the rear end 310b of the clamp 310 presses and supports the electrode plate 10, and at the same time the front end roller 320 disposed on the clamp 310 adjacent to the front end 310a of the clamp 310 presses and supports the electrode plate 10 so that shaking of the electrode plate 10 can be suppressed.

The clamp roller 340 may include the first roller 341, the second roller 342, and a roller driver 343.

The first roller 341 may be disposed inside the roller hole 311 of the clamp 310. The first roller 341 may contact a bottom surface of the electrode plate 10. The first roller 341 may press and support the electrode plate 10 together with the second roller 342, with the electrode plate 10 being disposed between the first and second rollers 341 and 342.

The second roller 342 may be disposed on the first roller 341. The second roller 342 may contact the front surface of the electrode plate 10. The second roller 342 may press and support the electrode plate 10 together with the first roller 341.

The roller driver 343 may support the second roller 342. The roller driver 343 may move the second roller 342 in the second direction (Z). That is, the second roller 342 may be moved in the second direction (Z) by the roller driver 343 to press and support the electrode plate 10.

Referring to FIGS. 2 and 3, the clamp driver 350 may support the clamp 310. The clamp driver 350 may move the clamp 310 in the first direction (X). Further, the clamp driver 350 may move the clamp 310 in the first direction (X), second direction (Z), third direction (Y), or other directions using various known means of movement.

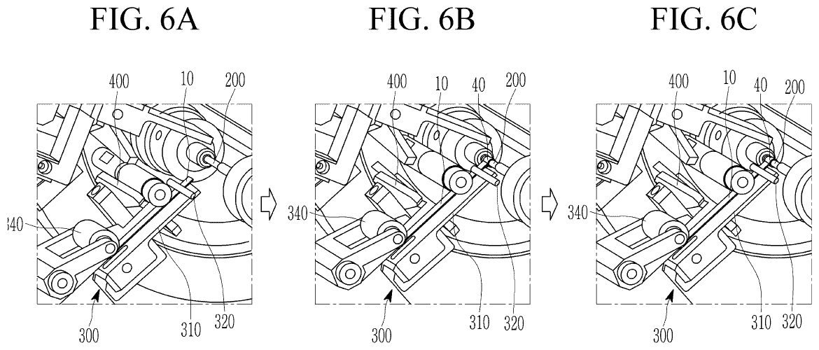

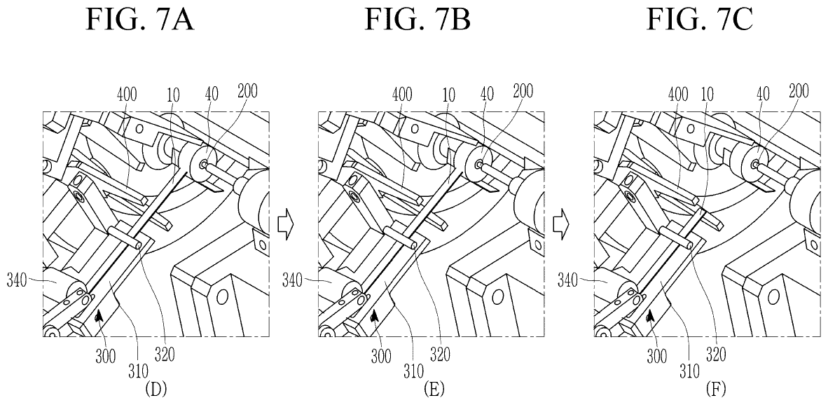

Hereinafter, referring to FIGS. 6 and 7, the apparatus for winding an electrode plate of a rechargeable battery that is inserted using the insert unit according to an embodiment will be described.

FIGS. 6 and 7 are perspective views showing the winding of the electrode plate winding. In particular, FIGS. 6 and 7 are perspective views of a region where the electrode plate is wound by the winding core portion in the apparatus according to an embodiment.

Referring to FIG. 6A, a cutter 400 for cutting the electrode plate 10 may be disposed between the clamp 310 of the insert unit 300 and the winding core portion 200 on which the electrode plate 10 is wound. The cutter 400 may include the first cutter or second cutter described above with reference to FIG. 1.

The front end of the clamp 310 may move in a direction closer to the winding core portion 200. The electrode plate 10 supported on the clamp 310 may be guided to the winding core portion 200 while being pressed and supported by the clamp roller 340 and the front-end roller 320 of the clamp 310. The front end roller 320 may be positioned closer to the cutter 400 than the clamp roller 340.

As the clamp 310 moves in one direction, and the front end of clamp 310 may pass through a cutting region of the cutter 400. The cutting region may include a region where the electrode plate 10 is cut by the cutter 400.

Referring to FIG. 6B, the electrode plate 10 supported by the clamp 310 is inserted into the winding core portion 200, and the electrode plate 10 is wound on the winding core portion 200 by 1 to 5 turns while being supported and pressed by the clamp roller 340 and the front-end roller 320 on the clamp 310. That is, the electrode plate 10 may be wound 1 to 2 turns on the winding core portion 200 while being supported and pressed by the clamp roller 340 and the front-end roller 320 on the clamp 310.

Referring to FIG. 6C, after the electrode plate 10 is wound on the winding core portion 200 by a predetermined number of turns while being supported and pressed by the clamp roller 340 and the front-end roller 320 on the clamp 310, the front end roller 320 moves in a vertical direction away from the electrode plate 10 so as not to release the electrode plate 10. In a state that the clamp roller 340 presses and supports the electrode plate 10 and the front-end roller 320 is spaced apart from the electrode plate 10, the electrode plate 10 may be further wound on the winding core portion 200 to wind the electrode assembly 40 in the form of a jelly roll.

Referring to FIG. 7A, the front end of clamp 310 may move in a direction away from the winding core portion 200. That is, in a state the clamp roller 340 presses and supports the electrode plate 10, and the front-end roller 320 is spaced from the electrode plate 10, the front end of the clamp 310 may move in a direction away from the winding core portion 200. The front-end roller 320 may be disposed between the clamp roller 340 and the cutter 400. As the clamp 310 moves in one direction, the front end of clamp 310 may pass through the cutting region of the cutter 400.

Referring to FIG. 7B, the front-end roller 320 may move in the vertical direction to contact the electrode plate 10 such that the front-end roller 320 moved into contact with the electrode plate 10. Thus, the electrode plate 10 supported on the clamp 310 may be supported by being pressed by the clamp roller 340 and the front-end roller 320 on the clamp 310.

Referring to FIG. 7C, the electrode plate 10 supported on the clamp 310 may be cut by the cutter 400 while being supported and pressed by the clamp roller 340 and the front-end roller 320 on the clamp 310. A non-tensioned area may be formed in a region of the electrode plate 10 disposed between the front end-roller 320 and cutter 400 due to cutting by the cutter 400, but another region of the electrode plate 10 disposed between the clamp roller 340 and the front end roller 320 is pressed and supported by the clamp roller 340 and the front end roller 320 such that shaking of the electrode plate 10 can be suppressed.

For example, the front-end roller 320 may move in a second direction including the vertical direction according to the cutting of the electrode plate 10 by the cutter 400 and selectively contact the electrode plate 10.

Afterwards, the front end of the clamp 310 is moved again in a direction approaching the winding core portion 200, and the electrode plate 10 is inserted into the winding core portion 200. Thus, another electrode assembly can be wound on the winding core portion 200.

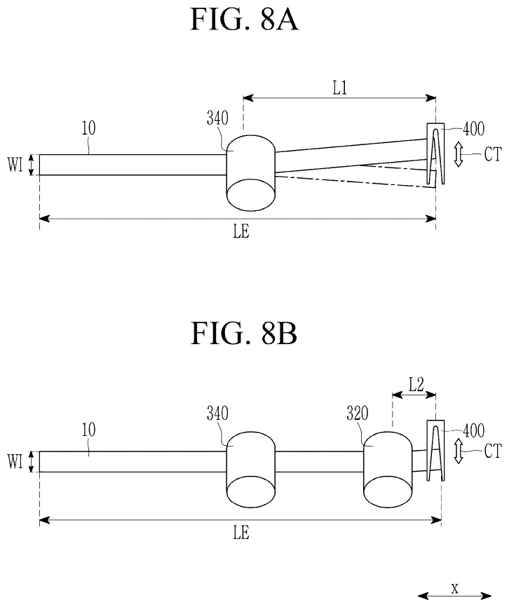

Hereinafter, an example of the effect of the apparatus for winding an electrode plate of a rechargeable battery according to an embodiment will be described with reference to FIG. 8.

FIG. 8 shows the effect of the apparatus for winding an electrode plate of a rechargeable battery according to an embodiment.

Referring to FIG. 8A, when the electrode plate 10 having a width WI of 1 mm to 10 mm and a length LE of 100 mm to 600 mm moves in the first direction (X) and is wound in the winding core portion, a non-tension region having a first length L1 may be formed in a region between the clamp roller 340 and the cutter 400 if the electrode plate 10 is cut (CT) by the cutter 400. Referring to FIG. 8B, when the electrode plate 10 having a width WI of 1 mm to 10 mm and a length LE of 100 mm to 600 mm moves in the first direction (X) and is wound in the winding core portion, a non-tension region having a second length L2 that is shorter than the first length L1 is formed in another region between the front end roller 320 and the cutter 400 if the electrode plate 10 is cut (CT) by the cutter 400. Thus, shaking and miswinding of the electrode plate 10 can be suppressed with the configuration shown in FIG. 8B.

According to embodiments of the present disclosure, an apparatus is provided for winding an electrode plate of a rechargeable battery that can suppress miswinding of the electrode plate 10 by including the front end controller 320. The apparatus may be particularly useful in the production of an ultra-small rechargeable battery.

Although embodiments have been described in detail above, the scope of the present disclosure is not limited to those embodiments, and various modifications and improvements made by a person of an ordinary skill in the art using the basic concept of the present disclosure.

### Description of Symbols

supply roller 101, winding core portion 200, insert unit 300, clamp 310, front end roller 320, clamp roller 340.

What is claimed is:

1. An apparatus for winding an electrode plate of a rechargeable battery, the apparatus comprising:
a supply roller configured to supply an electrode plate;
a winding core portion configured to wind the electrode plate; and
an insert unit that is disposed between the supply roller and the winding core portion, the insert unit being configured to insert the electrode plate in a first direction that the winding core portion is disposed,
wherein the insert unit comprises:
a clamp that extends in the first direction and supports the electrode plate to guide the electrode plate in the first direction and
a front-end roller that is disposed on the clamp at a position adjacent to a front end of the clamp, and the front-end roller being configured to move in a second direction that crosses the first direction to press the electrode plate supported by the clamp.

2. The apparatus as clamed in claim 1, wherein the insert unit further comprises a clamp roller that is adjacent to a rear end of the clamp, the insert unit being configured to press the electrode plate.

3. The apparatus as clamed in claim 2, wherein a diameter of the clamp roller is larger than a diameter of the front-end roller.

4. The apparatus as clamed in claim 2, wherein the clamp roller comprises:
a first roller contacting a bottom surface of the electrode plate; and
a second roller contacting a front surface of the electrode plate.

5. The apparatus as clamed in claim 4, wherein the clamp comprises a hole, with the first roller being located in the hole.

6. The apparatus as clamed in claim 4, wherein the clamp roller further comprises a roller driver that moves the second roller in the second direction.

7. The apparatus as clamed in claim 2, further comprising a cutter that is disposed between the clamp and the winding core portion, the cutter being configured to cut the electrode plate.

8. The apparatus as clamed in claim 7, wherein the front-end roller is positioned closer to the cutter than the clamp roller is positioned to the cutter.

9. The apparatus as clamed in claim 7, wherein the front-end roller is positioned between the clamp roller and the cutter.

10. The apparatus as clamed in claim 7, wherein:
the front-end roller is configured to move in the second direction according to the cutting of the electrode plate by the cutter such that the front-end roller selectively contacts the electrode plate.

11. The apparatus as clamed in claim 7, wherein the clamp is configured to move in the first direction such that the front end of the clamp selectively moves through the cutting region of the cutter.

12. The apparatus as clamed in claim 1, wherein the clamp is configured to move in the first direction such that a distance between the front end of the clamp and the winding core portion is adjusted.

13. The apparatus as clamed in claim 12, wherein the insert unit further comprises a clamp driver that supports the clamp and moves the clamp in the first direction.

14. The as clamed in claim 12, wherein the front-end roller is configured to move in the second direction to thereby selectively contact the electrode plate.

15. The apparatus as clamed in claim 14, wherein the insert unit further comprises a front-end roller driver that supports the front-end roller and moves the front-end roller in the second direction.

16. The apparatus as clamed in claim 15, wherein the front end roller driver comprises:
a linear cylinder portion that supports the front-end roller and moves in the second direction; and
a bush portion that guides the linear cylinder portion in the second direction.

17. The apparatus f as clamed in claim 1, wherein:
the front-end roller comprises:
a pressing roller configured to press the electrode plate; and
a bearing portion for rotating the pressing roller.

18. The apparatus as clamed in claim 17, wherein the bearing portion has a longer length than the roller in a third direction that crosses the first direction and the second direction.

19. The apparatus as clamed in claim 18, wherein the clamp comprises a recessed portion that is recessed in the third direction, with the recessed portion corresponding to the bearing portion.

20. The apparatus as clamed in claim 1, wherein the apparatus is configured to accommodate an electrode plate having a width of 1 mm to 10 mm.
